(19) United States
(12) Patent Application Publication
(10) Pub. No.: US 2025/0148323 A1
(43) Pub. Date: May 8, 2025

(54) INFORMATION PROCESSING APPARATUS, INFORMATION PROCESSING METHOD, AND COMPUTER-READABLE RECORDING MEDIUM

(71) Applicant: NEC Corporation, Minato-ku, Tokyo (JP)

(72) Inventor: Daichi Kimura, Tokyo (JP)

(73) Assignee: NEC Corporation, Minato-ku, Tokyo (JP)

(21) Appl. No.: 18/730,050

(22) PCT Filed: Mar. 7, 2022
(86) PCT No.: PCT/JP2022/009760

§ 371 Date: Jul. 18, 2024

(51) Int. Cl. G06N 5/04

(52) U.S. Cl. CPC G06N 5/042

(57) ABSTRACT

An information processing apparatus including: integrating unit that integrates, using observed event information representing an observed event that has been observed and rule information representing inference knowledge, a plurality of pieces of solution hypothesis information generated by weighted abduction processing; and detecting unit that detects differences between first integrated solution hypothesis information, which has been generated by the integrating means integrating one or more pieces of first solution hypothesis information generated using the observed event information and the rule information, and second integrated solution hypothesis information, which has been generated by the integrating means integrating one or more pieces of second solution hypothesis information generated when one or both of the observed event information and the rule information have changed.

### TECHNICAL FIELD

The present invention relates to an information processing apparatus and an information processing method for comparing inference results, and also to a computer-readable recording medium on which a program for realizing such apparatus and method is recorded.

### BACKGROUND ART

In the field of cybersecurity, when an event has been observed in a system, a determination of whether the observed event has been caused by a cyberattack is made and countermeasures are taken based on the determination result. As a method for making this determination, a method that uses abduction has been proposed.

Abduction is inference that uses an event that has been observed (or “observed event”) and inferred knowledge (or “rules”) provided as logic formulas to derive a hypothesis that provides the best explanation for an observed event. Accordingly, by applying an observed event in a system to rules that have been prepared in advance to derive a hypothesis, it is possible to determine whether the event was caused by a cyberattack.

However, the conditions (that is, the observed events and rules) used in abduction change over time. Since an observed event or rules will change when an error in an observed event has been corrected or when rules are updated to a latest state, the inference result of abduction will also change.

For this reason, it is desirable to compare inference results from before and after the conditions used for abduction have changed. The expression “changing of conditions” here refers to a change to the observed events, to the rules, or to both.

As a related technology, Patent Document 1 discloses an inference apparatus that generates an integrated graph by combining directed graphs, which are dynamically varying external information belonging to mutually different domains, using knowledge information provided from a knowledge base and inference rules provided from a rule database. The inference apparatus according to Patent Document 1 traces the nodes in the integrated graph through the edges and performs probabilistic inference (deductive inference, inductive inference, or abduction) to calculate the importance of each node as the inference result.

### LIST OF RELATED ART DOCUMENTS

### Patent Document

Patent Document 1: International Publication Pamphlet No. WO2021124502A1

### SUMMARY OF INVENTION

### Problems to be Solved by the Invention

However, the inference apparatus according to Patent Literature 1 does not compare the inference results before and after the conditions used for abduction are changed.

When, as the inference results of weighted abduction before and after a change to the conditions, a plurality of solution hypotheses are outputted for both before and after the change to the conditions, the inference results will not be easy to understand for the user. Weighted abduction is inference that generates hypothesis candidates based on observed events and rules and then selects the hypothesis candidate with the lowest total cost as the solution hypothesis (that is, the hypothesis that provides the best explanation: also referred to as the “inference result”).

An example object of the present disclosure is to provide an information processing apparatus, an information processing method, and a computer-readable recording medium capable of detecting differences between inference results before a change in conditions and inference results after a change in conditions, even when there are a plurality of solution hypotheses both before and after a change in conditions.

### Means for Solving the Problems

In order to achieve the example object described above, an information processing apparatus according to an example aspect includes:
integrating means for integrating, using observed event information representing an observed event that has been observed and rule information representing inference knowledge, a plurality of pieces of solution hypothesis information generated by weighted abduction processing; and
detecting means for detecting differences between first integrated solution hypothesis information, which has been generated by the integrating means integrating one or more pieces of first solution hypothesis information generated using the observed event information and the rule information, and second integrated solution hypothesis information, which has been generated by the integrating means integrating one or more pieces of second solution hypothesis information generated when one or both of the observed event information and the rule information have changed.

Also, in order to achieve the example object described above, an information processing method that is performed by a computer according to an example aspect includes:
an information processing apparatus executes processing comprising:
generating first integrated solution hypothesis information by integrating one or more pieces of first solution hypothesis information which have been generated weighted abduction processing using condition information including observed event information representing an observed event that has been observed and rule information representing inference knowledge;
generating second integrated solution hypothesis information by integrating one or more pieces of second solution hypothesis information, which have been generated using changed condition information in a case where one or both of the observed event information and the rule information in included in the condition information have changed; and
detecting differences between the first integrated solution hypothesis information and the second integrated solution hypothesis information.

Furthermore, in order to achieve the example object described above, a computer-readable recording medium according to an example aspect includes a program recorded on the computer-readable recording medium, the program including instructions that cause the computer to carry out:
(a) a step of generating first integrated solution hypothesis information by integrating one or more pieces of first solution hypothesis information which have been generated weighted abduction processing using condition information including observed event information representing an observed event that has been observed and rule information representing inference knowledge;
(b) a step of generating second integrated solution hypothesis information by integrating one or more pieces of second solution hypothesis information, which have been generated using changed condition information in a case where one or both of the observed event information and the rule information in included in the condition information have changed; and
(c) a step of detecting differences between the first integrated solution hypothesis information and the second integrated solution hypothesis information.

### Advantageous Effects of the Invention

According to one aspect, it is possible to detect the difference between inference results from before a change to conditions and inference results from after the change to the conditions, even when there is a plurality of solution hypotheses before and after a change to the conditions.

### BRIEF DESCRIPTION OF THE DRAWINGS

FIG. 1 is a diagram illustrating the generation of hypothesis candidates.

FIG. 2 is a diagram illustrating the derivation of a solution hypothesis.

FIG. 3 is a diagram illustrating a comparison of individual solution hypotheses.

FIG. 4 is a diagram illustrating one example of an information processing apparatus.

FIG. 5 is a diagram illustrating backward inference operations.

FIG. 6 is a diagram illustrating how conjunctions are handled in backward inference operations.

FIG. 7 is a diagram illustrating a case where the presence or absence of a conjunction is explicitly distinguished.

FIG. 8 is a diagram illustrating a case where the presence or absence of a conjunction is not distinguished.

FIG. 9 is a diagram illustrating a unification operation.

FIG. 10 is a diagram illustrating one example of the result (solution hypotheses) of executing weighted abduction.

FIG. 11 is a diagram illustrating one example of a union of literals.

FIG. 12 is a diagram illustrating one example a union of literals and backward inference operations.

FIG. 13 is a diagram illustrating an example of a union of literals, backward inference operations, and unification operations.

FIG. 14 is a diagram illustrating a comparison of integrated solution hypotheses.

FIG. 15 is a diagram illustrating the disappearance and appearance of hypothetical literals.

FIG. 16 is a diagram illustrating one example of a system including an information processing apparatus.

FIG. 17 is a diagram illustrating the presentation of disappearances and appearances of hypothetical literals.

FIG. 18 is a diagram illustrating the presentation of changes in the appearance locations of hypothetical literals.

FIG. 19 is a diagram illustrating the presentation of first structural changes to a backward inference operation.

FIG. 20 is a diagram illustrating the presentation of second structural changes to backward inference operations.

FIG. 21 is a diagram illustrating the presentation of the presence or absence of unification operations.

FIG. 22 is a diagram illustrating the operation of an information processing apparatus.

FIG. 23 is a diagram illustrating an example of a computer that realizes the information processing apparatus in the example embodiment.

### EXAMPLE EMBODIMENT

Abduction is described below.

Abduction is a type of inference that uses events (or “observed events” or “observations”) and inference knowledge (or “rules”) to derive a hypothesis that provides the best explanation for observed events.

An observed event is a set of logic formulas in which facts that have been established through observation or the like, or are known as common knowledge are expressed using first-order predicate logic formulas.

Rules are logic formulas or sets of logic formulas that express relationships (causal relationships or implicational relationships) between two events expressed by a first-order predicate logic formula whereby when one event is true, the other event will necessarily also be true. When the logic formula for one event is “A” and the logic formula for the other event is “B”, one rule is expressed by the logic formula “A→B”. Note that in the following description, the left side of the rule (that is, the left side of the logic symbol “→”) is called the “antecedent”, and the right side (that is, the right side of “→”) is called the “consequent”.

In more detail, abduction is inference which, for a rule “A→B” indicating that B holds true when A holds true, infers, when the observed event “B” (that is, “B holds true”) has been observed, that the likely reason that “B holds true” is that “A holds true”, and therefore establishes the hypothesis that “A holds true”.

Note that if “p” is a predicate symbol and “t1, t2 . . . ” are terms, “p(t1, t2 . . . )” is a prime formula (or “atomic formula”). Prime formulas, and prime formulas to which a negation sign has been attached, are literals.

If “P” and “Q” are logic formulas, “¬P”, “P∧Q”, “P∨Q”, and “P→Q” will also be logic formulas. The logic symbol “A” represents conjunction, the logic symbol “v” represents disjunction, the logic symbol “¬” represents negation, and “→” represents causation or implication.

A predicate symbol represents a relationship and a property regarding an object. Terms include constant symbols and variable symbols. Constant symbols represent individual objects that exist in a world that is to be represented. Variable symbols also represent objects in a world that is to be represented, and are used when the corresponding object has not been precisely determined. Note that in the following description, constant symbols are referred to as “constants” and variable symbols are referred to as “variables”. Constants are represented by character strings that begin with an uppercase letter or are enclosed in quotation marks. Variables are represented by other types of character strings.

Weighted abduction is inference that outputs hypothesis candidates based on observed events and rules and selects, out of the outputted hypothesis candidates, the hypothesis candidate with the lowest total cost as a solution hypothesis (which is the hypothesis that provides the best explanation, or “inference result”).

In weighted abduction, a cost is assigned to the literal of an observed event (or “observed literal”). As one example, if the observed literals are the “murder(A)”, “police(B)”, and “arrest(B,A)”, assigning a cost of “10” to each observed literal produces the expressions ““murder(A)”:10,” “police(B):10,” and “arrest(B,A):10”. The cost here is an index expressing to what extent that observed literal should be explained.

Each literal that is the antecedent of a rule is also assigned a weight. As one example, if rules are “kill(x,y)→arrest(z,x)” and “kill(x,y)→murder(x)”, assigning the weights “1.4” and “1.2” to the antecedent literals “kill(x,y)” and “kill(x,y)” results in the rules being expressed as “kill(x,y): 1.4→arrest(z,x)” and “kill(x,y): 1.2→murder(x)”. The weight is an index expressing how unreliable it is to infer the antecedent from the consequent. Note that in the following description, costs and weights may be omitted when unnecessary to describe the present embodiments.

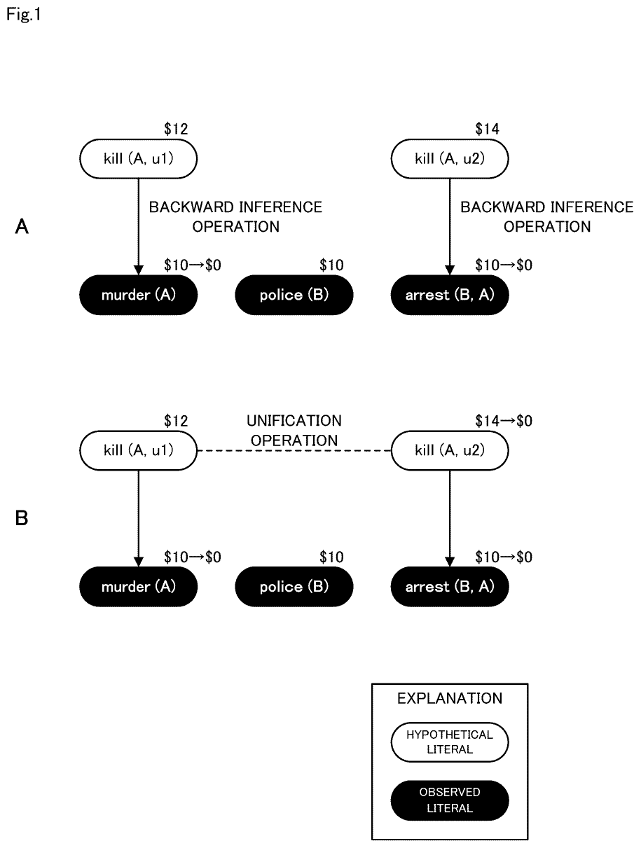

Hypothesis candidates are generated by combining backward inference operations and unification operations. FIG. 1 is a diagram illustrating the generation of hypothesis candidates.

Part A in FIG. 1 is a diagram illustrating backward inference operations. Part B in FIG. 1 is a diagram illustrating a unification operation.

A backward inference operation is an operation in which a hypothesis is established by tracing a rule backwards. That is, a backward inference operation generates a literal (or “hypothetical literal”) representing a hypothetical event. In the example in FIG. 1, shapes (rectangles with rounded corners: see the legend in FIG. 1) representing observed literals and hypothetical literals are depicted, with their costs indicated above the shapes in the form of “$◯◯”. Here, “$” is the symbol indicating expressions of cost, and the number (◯◯) next to “$” represents the cost itself.

The cost of an observed literal (that is, the cost belonging to the grounds for the inference) is entirely propagated to a hypothetical literal. The cost of a hypothetical literal is the cost belonging to the grounds for the inference multiplied by the weight of the rule. As one example, if the cost of an observed literal is “10” and the weight is “1.2”, the cost of the hypothetical literal will be “12”.

A unification operation is an operation that establishes a hypothesis that literals with the same predicate symbol are the same. As one example, for the case of the hypothetical literals “kill (A, u1)” and “kill (A, u2)”, unification of these hypothetical literals means that these hypothetical literals are regarded as being the same. For this reason, the variables “u1” and “u2” included in these hypothetical literals are considered to be the same.

Note that when a unification operation is performed, the higher cost out of the costs of the two hypothetical literals that are unified is canceled. In the example in part B in FIG. 1, out of “$12” and “$14” expressing the respective costs, “$14” is the higher cost and is therefore canceled and becomes “$0”.

The total cost of all the hypothesis candidates is calculated using Equation 1 for example.

$${\sum }_{p ∈ H} cost ( p ) \\ H : Hypothesis Candidate \\ p : Literal \\ cost ( p ) : Cost of p \qquad ( Equation 1 )$$

In the example in part B in FIG. 1, the total cost is “$22” (=“$10”+“$12”).

The solution hypothesis is the hypothesis candidate with the lowest total cost out of the hypothesis candidates. The derivation of a solution hypothesis will now be described in detail.

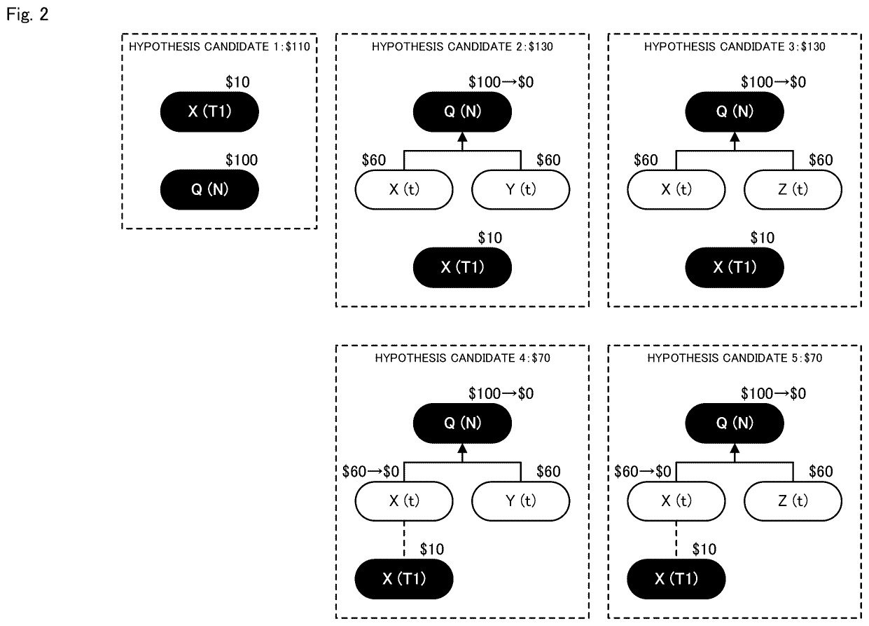

FIG. 2 is a diagram illustrating the derivation of a solution hypothesis. FIG. 2 depicts the results (the hypothesis candidates 1 to 5) of applying weighted abduction to a rule “X(t1):0.6∧Y(t1):0.6→Q(n),X(t2):0.6∧Z(t2):0.6→Q(n)” and the observed event “X(T1):10∧Q(N):100”.

As one example, the hypothesis candidate 1 is a hypothesis candidate to which no backward inference operation or unification operation has been applied.

The hypothesis candidate with the lowest total cost is the solution hypothesis, so that out of the hypothesis candidates 1 to 5 in FIG. 2, the solution hypotheses are the hypothesis candidates 4 and 5. In this way, a plurality of solution hypotheses with the same cost but different compositions may exist.

The following description is provided for ease of understanding the example embodiment s.

As one example, when weighted abduction executed before the conditions (that is, observed events and rules) change is referred to as “Inference A”, and the weighted abduction executed after the conditions have changed is referred to as “Inference B”, assume that the number of solution hypotheses (that is, the hypotheses with the lowest cost) for Inference A is KA (a plural number), and the number of solution hypotheses for Inference B is KB (also a plural number).

In this case, simple one-to-one comparisons of the plurality of solution hypotheses of Inference A and the plurality of solution hypotheses of Inference B will require KA×KB comparisons. The expression “comparison” here refers for example to an operation for finding common parts and differences between solution hypotheses.

When such simple comparisons are performed, the following problems (1) and (2) will arise.
(1) The number of comparison results obtained will increase explosively as the number of solution hypotheses increases, making it difficult to list the comparison results.
(2) When there has been an explosive increase in the number of comparison results, overall trends in the differences between the solution hypotheses of Inference A and the solution hypotheses of Inference B cannot be easily grasped from individual comparison results.

In other words, it is difficult to understand what hypothetical parts disappear and what hypothetical parts appear due to the change in conditions.

One example of this is a case where a hypothetical literal that is generally included in a plurality of solution hypotheses of Inference A disappears in a solution hypothesis of Inference B.

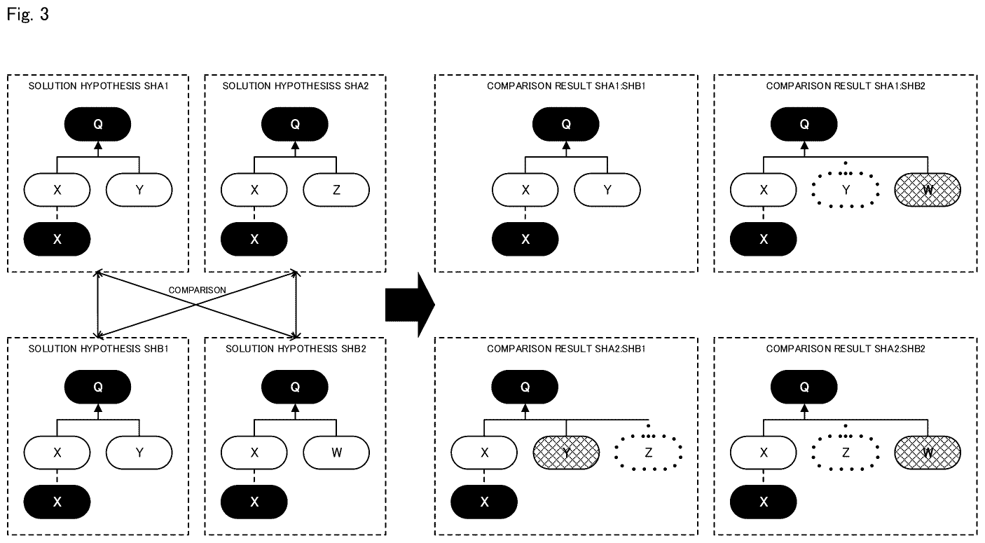

FIG. 3 is a diagram illustrating a comparison of individual solution hypotheses. The two solution hypotheses SHA1 and SHA2 of Inference A in FIG. 3 are inference results obtained by applying weighted abduction to the rule “X(t1): 0.6∧Y(t1): 0.6→Q(n), X(t2):0.6∧Z(t2): 0.6→Q(n)” and the observed event “X(T1): 10∧Q(N): 100”.

The two solution hypotheses SHB1 and SHB2 of Inference B in FIG. 3 are inference results obtained by applying weighted abduction to the rule “X(t1): 0.6∧Y(t1): 0.6→Q(n), X(t2): 0.6∧W(t2): 0.6→Q(n)” and the observed event “X(T1): 10∧Q(N): 100”.

In the example in FIG. 3, the frame borders of the nodes representing the hypothetical literals “Y” and “Z” that disappear are drawn as dotted lines, and the frames of the nodes representing the hypothetical literals “Y” and “W” that appear are crosshatched. Directed links (arrows) of the backward inference operations “Y→Q” and “Z→Q” that disappear are also drawn as dotted lines. Note that in the following description, directed links are expressed as “→”.

In other words, in Inference B, out of the rules used in Inference A, “X(t2): 0.6∧Z(t2): 0.6→Q(n)” is deleted, and “X(t2): 0.6∧W(t2): 0.6→Q(n)” is added as a new rule. Note that terms and costs have been omitted from the example in FIG. 3 for ease of explanation. Terms and costs may also be omitted from other drawings described below.

In the example in FIG. 3, when the solution hypotheses SHA1 and SHB1 are compared, the solution hypotheses SHA1 and SHB2 are compared, the solution hypotheses SHA2 and SHB1 are compared, and the solution hypotheses SHA2 and SHB2 are compared, SHA1:SHB1, SHA1:SHB2, SHA2:SHB1, SHA2:SHB2 are obtained as the comparison results in FIG. 3.

When focusing on the comparison result SHA1:SHB1, there is no difference between the structure of the solution hypothesis SHA1 and the structure of the solution hypothesis SHB1. For the comparison result SHA1:SHB2, the hypothetical literal “Y” disappears from the structure of the solution hypothesis SHA1 and the solution hypothesis SHB1 has a structure in which the hypothetical literal “W” appears. In the comparison result SHA2:SHB1, the hypothetical literal “Z” disappears from the structure of the solution hypothesis SHA2, and the solution hypothesis SHB1 has a structure in which the hypothetical literal “Y” appears. In the comparison result SHA2:SHB2, the hypothetical literal “Z” disappears from the structure of the solution hypothesis SHA2, and the solution hypothesis SHB2 has a structure in which the hypothetical literal “W” appears.

However, as described earlier, it is difficult to grasp overall trends in the differences between the solution hypotheses of Inference A and the solution hypotheses of Inference B from such individual comparison results.

One reason for this difficulty for the example in FIG. 3 is that with the comparison result SHA1:SHB2 and the comparison result SHA2:SHBT in FIG. 3, since the hypothetical literal “Y” disappears in the comparison result SHA1:SHB2 but “Y” appears in the comparison result SHA2:SHB1, such hypothetical literals “Y” must be considered as canceling themselves out.

This is because as mentioned above, there is no difference in structure between SHA1, which out of the solution hypotheses of Inference A includes the hypothetical literal “Y”, and SHB1, which out of the solution hypotheses of Inference B includes the hypothetical literal “Y”.

That is, to grasp the difference between all solution hypotheses of Inference A and all solution hypotheses of Inference B, it is necessary to make changes like cancelling out the hypothetical literal “Y”. Accordingly, deriving the differences between all solution hypotheses of Inference A and all solution hypotheses of Inference B is extremely complicated.

Using a different example to the example in FIG. 3, it will now be demonstrated that differences cannot be detected by simply stacking KA×KB individual comparison results. As one example, consider the result of comparing one of the solution hypotheses for Inference A (referred to as “SHA1”) with all KB solution hypotheses for Inference B. This comparison would produce KB comparison results.

If the solution hypotheses of Inference B include an identical hypothesis to the solution hypothesis SHA1, a comparison will be made between the two identical hypotheses (that is, the solution hypothesis SHA1 with itself) and that comparison result will find no difference between the hypotheses. That is, even if the conditions have changed, the solution hypothesis SHA1 is still obtained as the solution hypothesis without being affected by the change.

At this time, although there will be differences in the remaining (KB−1) comparison results (that is, comparison results between SHA1 and the other solution hypotheses of Inference B (≠SHA1)), such comparison results may or may not have any meaning depending on whether inference A has other solution hypotheses.

As one example, if KA=1 (that is, the only solution hypothesis is SHA1) and KB>1 (that is, there is one or more solution hypotheses aside from SHA1), the remaining (KB−1) comparison results as they are will be the differences between Inference A and Inference B. However, if KA=KB and all solution hypotheses of Inference A are the same as the solution hypotheses of Inference B, Inference A and Inference B are to be regarded has having no difference between them since what is being examined is whether any difference exists between the solution hypotheses of Inference A as a whole and the solution hypotheses of Inference B as a whole.

However, since the remaining (KB−1) comparison results mentioned above will be the results of comparing a single solution hypothesis SHA1 and solution hypotheses that differ from it, differences will naturally exist. In the same way, if differences in the KA×KB comparison results are simply accumulated, an inappropriate conclusion that differences exist between Inference A and Inference B will be reached.

This indicates that the results of individual comparisons are not to be simply accumulated, and that it is necessary to consider that the result of one comparison may cancel out the result of another comparison. As one example, if the literal “X” disappears from one comparison result but the literal “X” appears in another comparison result, no difference will remain when such results are combined.

In addition, if a solution hypothesis of Inference A and a solution hypothesis of Inference B are the same, it is sufficient to associate such hypotheses and no need to make comparisons with other solution hypotheses (that is, there is no need to derive comparison results in which difference exist). However, when solution hypotheses that are identical do not exist, there will always be a plurality of comparison results in which differences exist and it will be necessary to compare the comparison results and distinguish between results that cancel each other out and results including true differences. Accordingly, when deriving differences from KA×KB individual comparison results, derivation of differences is extremely complicated.

Through the process described above, the inventors of the present invention discovered a problem that with the method described earlier, when there are a plurality of solution hypotheses before and after the conditions change, it is not possible to easily grasp the differences in the inference results before and after the conditions change, and along with making this discovery, conceived a means to solve this problem.

That is, the inventors of the present invention were able to derive a means which, by using comparison results between an integrated solution hypothesis produced by integrating a plurality of solution hypotheses before conditions change and an integrated solution hypothesis produced by integrating a plurality of solution hypotheses after the conditions change (that is, comparison results in which duplication has been removed), can easily grasp the differences in inference results before and after the conditions change. As a result, differences in inference results due to changes in conditions can be presented to the user in an easy-to-understand manner.

### Example Embodiment

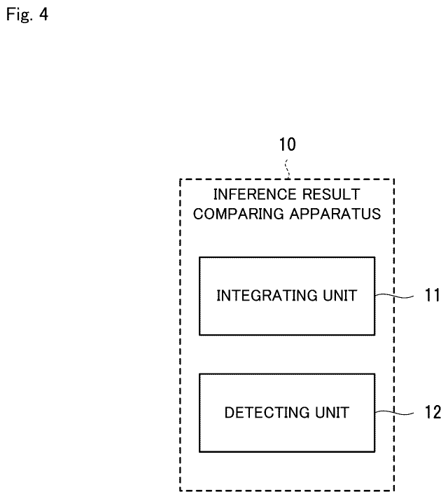

The configuration of an information processing apparatus 10 according to an example embodiment will now be described with reference to FIG. 4. FIG. 4 is a diagram illustrating one example of an information processing apparatus.

### [Apparatus Configuration]

The information processing apparatus 10 depicted in FIG. 4 is an apparatus that presents differences in inference results due to a change in conditions to the user in an easy-to-understand manner. As depicted in FIG. 4, the information processing apparatus 10 includes an integrating unit 11 and a detecting unit 12.

The integrating unit 11 integrates a plurality of pieces of solution hypothesis information generated by a weighted abduction process using observed event information representing observed events and rule information representing inference knowledge.

The integration of a plurality of pieces of solution hypothesis information will now be described. Processing that integrates solution hypothesis information is processing that derives, for a plurality of pieces of solution hypothesis information generated under the same conditions, a union for each type of element (literals, backward inference operations, or unification operations) that compose the solution hypothesis information.

### (A) Integration Processing for Literals

When the predicate symbol, the values of terms, and the presence or absence of a negation symbol are the same in a literal included in one solution hypothesis and a literal included in another solution hypothesis, such literals are determined to be the same. In other words, such literals are regarded as duplicates when deriving a union.

Regarding the presence or absence of a negation symbol, a case with no negation symbol (a positive literal “X(N,M)” where N and M are constants) and a case with a negation symbol (a negative literal “¬X(N,M)”)”) are determined to be different.

However, if a term in both literals is a variable, such term may be determined to be the same. Also, an observed literal and a hypothetical literal are not determined to be the same.

As one example, for a hypothetical literal “X(N,M)” included in a certain solution hypothesis, the only literal included in another solution hypothesis that would be regarded as being the same would be a hypothetical literal “X(N,M)”. Even if an observed literal “X(N,M)” were included in another solution hypothesis, such literals would not be determined as being the same.

In addition, if the second term of the hypothetical literal “X(N,m)” included in a certain solution hypothesis is a variable, and a hypothetical literal “X(N,p)” where the second term is also a variable exists in another solution hypothesis, the values of these second terms are determined to be the same. Accordingly, these literals are determined to be the same.

However, the hypothetical literal “X (N,m)” is not determined to be the same as either a hypothetical literal “X (N,M)” (whose second term is a constant) included in another solution hypothesis or an observed literal “X (N,p)”.

### (B) Integration Processing for Backward Inference Operations

If one or more hypothetical literals corresponding to an antecedent has been generated, by a backward inference operation using a rule, from one or more hypothetical literals corresponding to a consequent or from an observed literal, a backward inference operation is performed by associating directed links from each literal in the antecedent to each literal in the consequent.

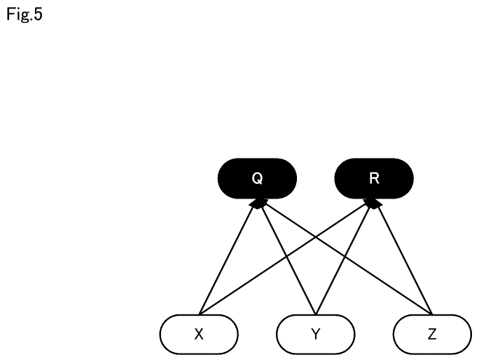

As one example, when the rule “X(a)∧Y(b)∧Z(c)→Q(n)∧R(m)” is used for the observed literals Q(N) and R(M) and a hypothetical literals X(a), Y(b) and Z(c) have been generated by backward inference operations, as depicted in FIG. 5, the backward inference operations are handled as individual directed links, such as “X” to “Q”, “Y” to “R”, and the like as depicted in FIG. 5. FIG. 5 is a diagram illustrating backward inference operations. The links (arrows) in FIG. 5 represent backward inference operations. Note that the direction of each link is from an antecedent to a consequent.

When it is determined for a backward inference operation (link) in one solution hypothesis and a backward inference operation (link) in another solution hypothesis that the link-source literals are the same and the link-destination literals are the same, the links are determined to be the same. In other words, the links are regarded as duplicates when deriving a union.

Note that the condition for literals to be regarded as the same is the same as described earlier. For the rule in the example in FIG. 5, for the link from “X” to “Q”, when “X” as the link source of one solution hypothesis and “Q” as the link source are determined to be the same as the link source “X” of another solution hypothesis and the link source “Q”, the links are also determined to be the same.

The handling of conjunctions in backward inference operations will now be described. When directed link are regarding as existing between literals as described above, this means that there will be no distinguishing between the presence or absence of a conjunction when deriving the union of backward inference operations.

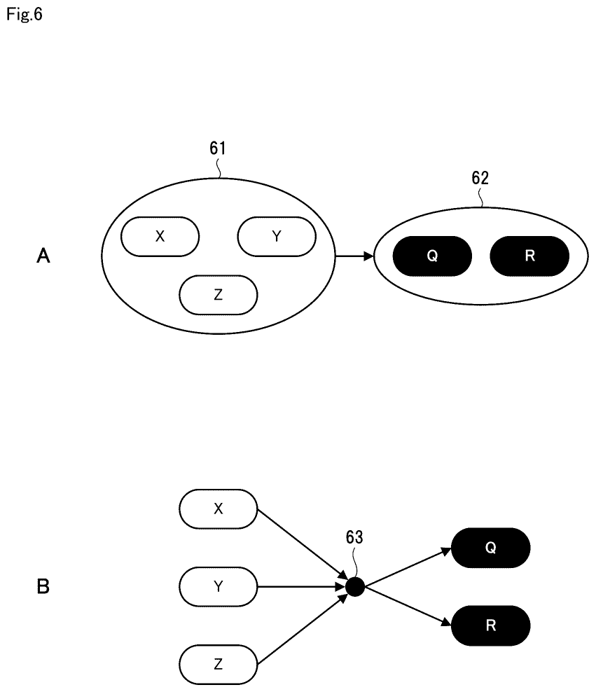

FIG. 6 is a diagram illustrating how conjunctions are handled in backward inference operations. When it is clearly distinguished whether a conjunction is present or absent, as depicted in part A in FIG. 6, backward inference operations may be treated as a directed hyperlink that joins a hypernode 61 including “X”, “Y”, and “Z” and a hypernode 62 including “Q” and “R”.

Alternatively, as depicted in part B in FIG. 6, the operation may be treated as a set of links from “X”, “Y”, and “Z” to a node 63 and links from the node 63 to “Q” and “R”.

In addition, when explicitly distinguishing whether a conjunction is present or absent as described earlier, if the literals of the respective antecedents and the literals of the respective consequents are all identical between one solution hypothesis and another solution hypothesis, the backward inference operations are determined to be the same. Although a case where it is explicitly distinguished whether a conjunction is present or absent is not described below, it should be obvious that this can be handled in the same way as the case of directed links where the presence or absence of a conjunction is not distinguished.

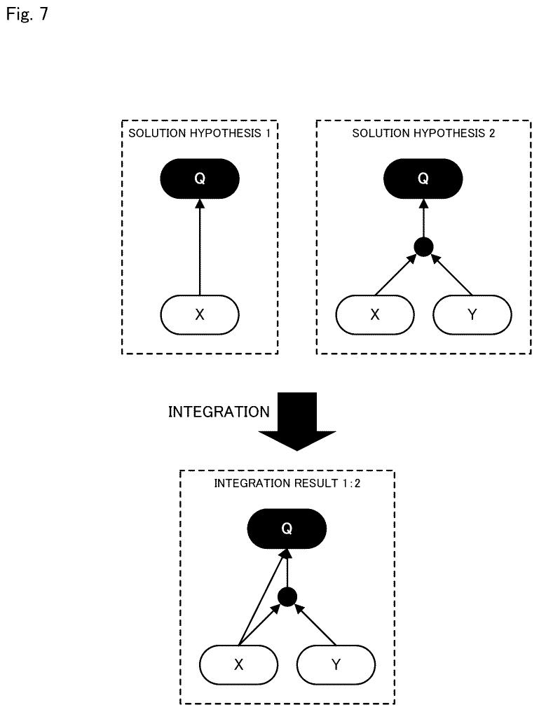

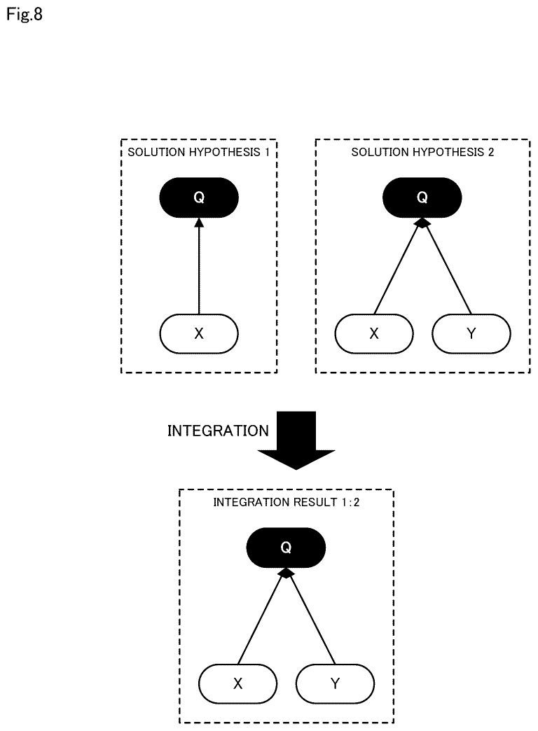

FIG. 7 is a diagram illustrating a case where the presence or absence of a conjunction is explicitly distinguished. Note that in FIG. 7, backward inference operations are handled by the method depicted in part B of FIG. 6. FIG. 8 is a diagram illustrating a case where the presence or absence of a conjunction is not distinguished.

In FIGS. 7 and 8, in solution hypothesis 1, a hypothetical literal X(a) is generated by backward inference operation using a rule “X(a)→Q(n)” on an observed literal Q(N), and in solution hypothesis 2, hypothetical literals X(a) and Y(b) are generated by backward inference operations using the rule “X(a)∧Y(b)→Q(n)” on the observed literal Q(N). When conjunctions are explicitly distinguished, for “X” and “Q” in FIG. 7, a directed link is connected directly from “X” to “Q” in solution hypothesis 1 and a directed link from “X” to anode is connected and another directed link from the node to “Q” is connected in solution hypothesis 2.

This means that when solution hypotheses 1 and 2 in FIG. 7 are integrated, as depicted in FIG. 7, a directed link that goes directly from “X” to “Q” representing “X→Q” and a directed link from “X” to a node and a directed link from the node to “Q” representing parts of “X∧Y→Q” are distinguished. When conjunctions are not distinguished, for “X” and “Q” in FIG. 8, in both solution hypothesis 1 and solution hypothesis 2, a directed link is directly connected from “X” to “Q”. This means that when solution hypotheses 1 and 2 in FIG. 8 are integrated, as depicted in FIG. 8, the directed link from “X” to “Q” representing “X→Q” and a directed link from “X” to “Q” representing part of “X∧Y→Q” are regarded as the same and are therefore integrated as a “X→Q” link.

### (C) Integration Process for Unification Operations

When a unification operation is applied to a pair of literals with the same predicate symbol, the unification operation is treated as an undirected link linking the literals.

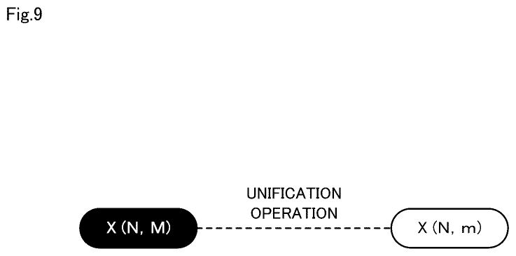

As one example, when a unification operation is applied to an observed literal X(N,M) and a hypothetical literal X(N,m), this is represented as depicted in FIG. 9. FIG. 9 is a diagram illustrating a unification operation. The broken line in FIG. 9 represents a unification operation.

A unification operation (link) of one solution hypothesis and a unification operation (link) of another solution hypothesis are determined to be the same link when the literals at one end of each link are the same and the literals at the other end of each link are the same. In other words, the solution hypotheses are regarded as duplicates when deriving a union. Note that the conditions for literals to be regarded as the same were described earlier.

Generation of integrated solution hypothesis information will now be described in detail.

The integrating unit 11 uses literal information representing literals, backward inference operation information representing backward inference operations, and unification operation information representing unification operations, all of which are included in solution hypothesis information representing a plurality of solution hypotheses generated by a weighted abduction process, to calculate a union of the literals, a union of the backward inference operations, and a union of the unification operations, and generates integrated solution hypothesis information representing an integrated solution hypothesis, which is a set composed of the union of the literals, the union of the backward inference operations, and the union of the unification operations.

That is, the integrating unit 11 uses literal information representing literals, backward inference operation information representing backward inference operations, and unification operation information representing unification operations, all of which are included in solution hypothesis information representing a plurality of solution hypotheses generated by the same weighted abduction process, to calculate a union of the literals, a union of the backward inference operations, and a union of the unification operations using the processing in (A), (B), and (C) described above, and thereby generates a set (or “integrated solution hypothesis information”) composed of these unions.

The integrated solution hypothesis information includes literal information representing literals (that is, observed literal information and hypothetical literal information), backward inference operation information representing the relationship between literals and backward inference operations, and unification operation information representing literals and unification operations.

The observed literal information includes observed literal identification information that identifies the observed literal information, and information representing the contents (logic formulas) of observed literals. The hypothetical literal information includes hypothetical literal identification information that identifies the hypothetical literal information, and information representing the contents (logic formulas) of the hypothetical literals.

In more detail, the integrating unit 11 first acquires solution hypothesis information representing one or more solution hypotheses that have been stored in a storage device and were generated based on condition information (observed event information and rule information).

The solution hypothesis information is information about a solution hypothesis that was generated by executing a weighted abduction process using the following condition information, for example. The condition information indicated below is merely one example to which the present embodiments are not limited.

### Rules:

X(t1):0.5∧Y(t1):0.5→Q(n)
X(t2):0.5∧Z(t2):0.5→Q(n)
W(t3):0.5∧Z(t3):0.5→Q(n)∧R(n)
V(t4):0.5∧Z(t4):0.5→Q(n)
U(t5):1.0→V(t5)
S(t6):1.0→V(t6)
U(t5):1.0→S(t5)

### Observed Events:

X(T1):10∧U(T2):10∧W(T3):10∧W(T4):10∧Q(N):100∧R(N):0

As one example, in the field of cybersecurity, X, Y, Z, W, V, U, and S are specific examples of predicates indicating traces that may be left when a cyberattack has occurred. As examples, these traces may include “execution of a suspicious program”, “a large amount of data communication” and “registration of a periodically executed task”.

These traces are extracted from logs stored in a computer, a proxy server, or the like, that is, observation of these traces will generate an observed literal as one type of observed event. Q is a predicate that indicates a query for performing abduction, that is, a query about whether there has been a cyberattack. R is a predicate indicating constraints on the query (such as the time period and domain under investigation). Since Q and R are queries for performing abduction, they are treated as given observations. t1 to t6 and T1 to T4 are terms indicating time. n, N are formal terms given to a query.

The integrating unit 11 next uses one or more solution hypothesis information to calculate (a) a union of literals, (b) a union of backward inference operations, and (c) a union of unification operations and thereby generates integrated solution hypothesis information.

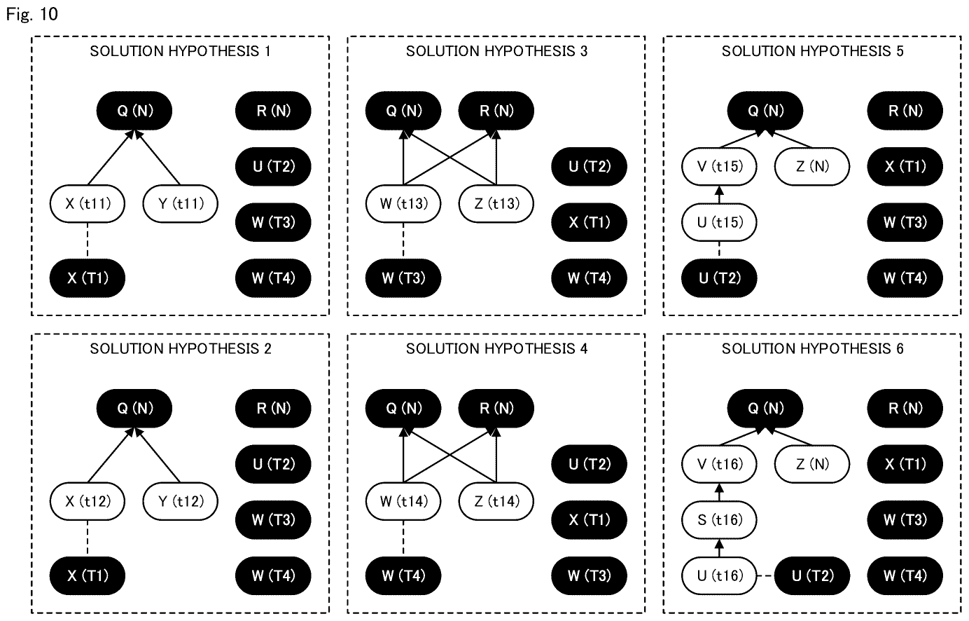

As one example, when solution hypotheses 1 to 6 such as those depicted in FIG. 10 have been obtained as a result of the weighted abduction, the integrating unit 11 executes the process of generating integrated solution hypothesis information as described below.

FIG. 10 is a diagram illustrating one example of the result (solution hypotheses) of executing weighted abduction. Note that in FIG. 10, backward inference operations are handled without distinguishing between the presence and absence of conjunctions.

(a) Processing that Derives a Union of Literals Will Now be Described.

As one example, all the observed literals included in solution hypotheses 1 to 6 in FIG. 10 are determined to be the same. In other words, since these are solution hypotheses for inference under the same conditions, the observed literals do not differ between the solution hypotheses.

Regarding the hypothetical literals included in the solution hypotheses 1 to 6 in FIG. 10, since the value of the terms in “X(t11)” of solution hypothesis 1 and “X(t12)” of solution hypothesis 2 are variables, the two literals are determined to be the same.

In the same way: “Z(t12)” of solution hypothesis 2, “Z(t13)” of solution hypothesis 3, and “Z(t14)” of solution hypothesis 4; “W(t13)” of solution hypothesis 3 and “W(t14)” of solution hypothesis 4; “V(t15)” of solution hypothesis 5 and “V(t16)” of solution hypothesis 6; “U(t15)” of solution hypothesis 5 and “U(t16)” of solution hypothesis 6; and “Z(N)” of solution hypothesis 5 and “Z(N)” of solution hypothesis 6 are determined to be the same. Note that “Z(t12)” of solution hypothesis 2 and “Z(N)” of solution hypothesis 5 are not determined to be the same because the values of the terms are respectively a variable and a constant.

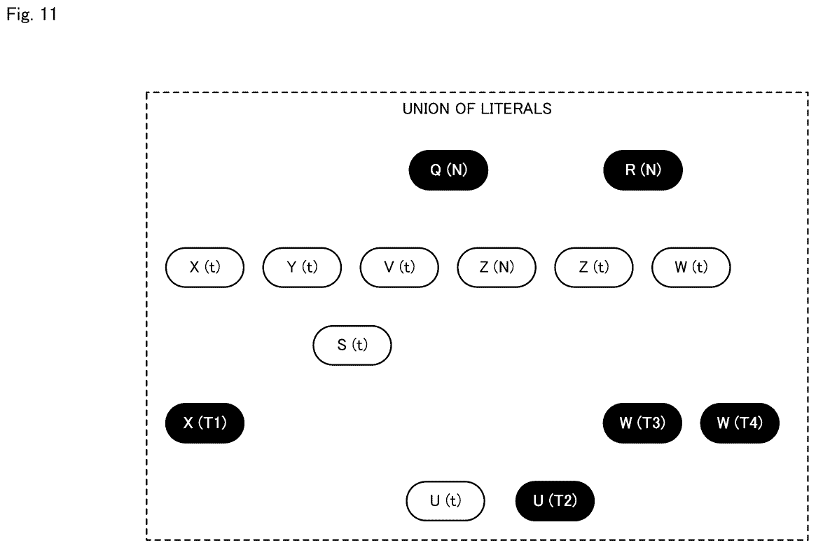

Through the processing described above, a union of literals like that depicted in FIG. 11 is obtained. Note that all of the variables are unified to “t”. FIG. 11 is a diagram illustrating one example of a union of literals.

(b) Processing that Derives a Union of Backward Inference Operations Will Now be Described.

When, for a plurality of solution hypotheses, the source literals of directed links (backward inference operations) and the destination literals of the directed links are determined to be the same, the directed links are also determined to be the same.

As one example, in FIG. 10, for “X(t11)→Q(N)” of solution hypothesis 1 and “X(t12)→Q(N)” of solution hypothesis 2, since “X(t11)” of solution hypothesis 1 and “X(t12)” of solution hypothesis 2, which are the link sources, and “Q(N)” of solution hypothesis 1 and “Q(N)” of solution hypothesis 2, which are the link destinations, are determined to be the same, the links themselves are also the same.

In the same way: “Z(t12)→Q(N)” of solution hypothesis 2, “Z(t13)→Q(N)” of solution hypothesis 3, and “Z(t14)→Q(N)” of solution hypothesis 4; “W(t13)→Q(N)” of solution hypothesis 3 and “W(t14)→Q(N)” of solution hypothesis 4; “Z(t13)→R(N)” of solution hypothesis 3 and “Z(t14)→R(N)” of solution hypothesis 4; “W(t13)→R(N)” of solution hypothesis 3 and “W(t14)→R(N)” of solution hypothesis 4; “V(t15)→Q(N)” of solution hypothesis 5 and “V(t16)→Q(N)” of solution hypothesis 6; and “Z(N)→Q(N)” of solution hypothesis 5 and “Z(N)→Q(N)” of solution hypothesis 6 are determined to be the same.

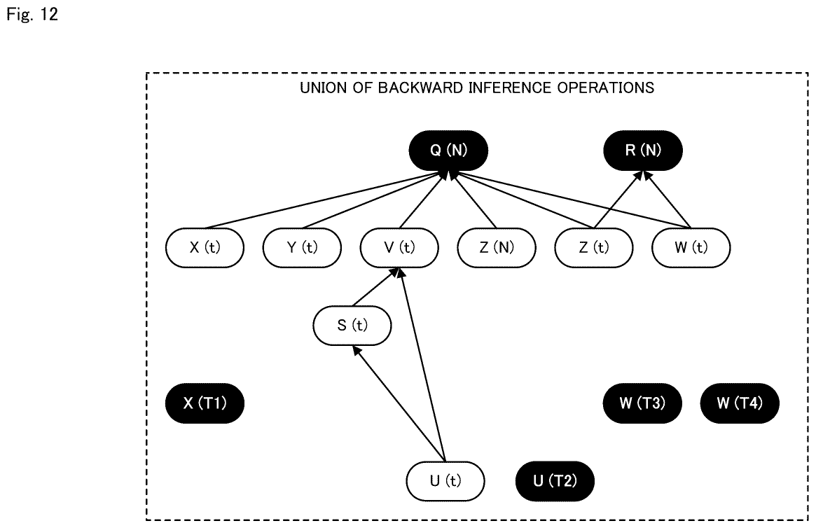

Through the processing described above, a union of backward inference operations that has been combined with literals, such as that depicted in FIG. 12, is obtained. FIG. 12 is a diagram illustrating one example a union of literals and backward inference operations.

(c) Processing that Derives a Union of Unification Operations Will Now be Described.

When, in a plurality of solution hypotheses, the literals at one end of an undirected link (that is, a unification operation) and the literals at the other end are respectively determined to be the same, the links are also determined to be the same.

As one example, in FIG. 10, for “X(t11)˜X(T1)” of solution hypothesis 1 and “X(t12) X(T1)” of solution hypothesis 2, since “X(t11)” of solution hypothesis 1 and “X(t12)” of solution hypothesis 2, which are one end of the links, and “X(T1)” of solution hypothesis 1 and “X(T1)” of solution hypothesis 2, which are the other ends of the links, are determined to be the same, the links are also the same.

In the same way, “U(t15)˜U(T2)” of solution hypothesis 3 and “U(t16)˜U(T2)” of solution hypothesis 4 are determined to be the same. Note that, in the following description, undirected links are indicated as “˜”.

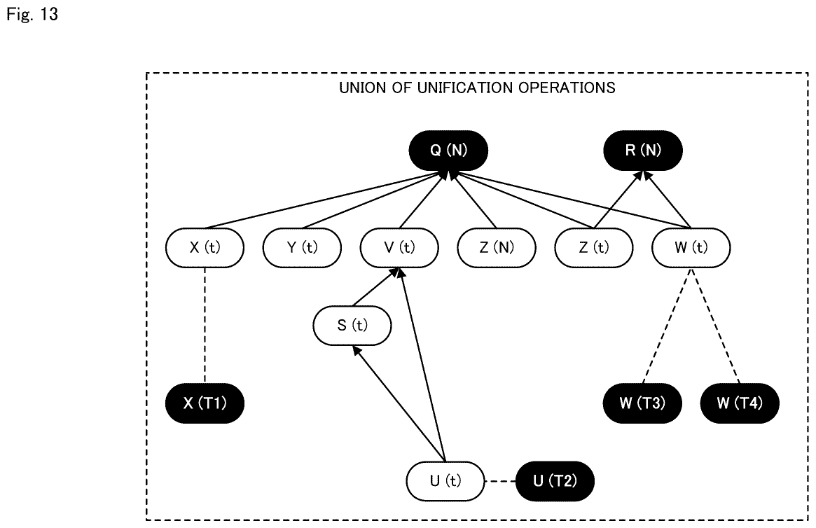

Through the processing described above, a union of unification operations like that depicted in FIG. 13 and in which literals and backward inference operations have been combined is obtained. FIG. 13 is a diagram illustrating an example of a union of literals, backward inference operations, and unification operations.

In this way, the integrating unit 11 performs the processing described in (a), (b), and (c) above to generate integrated solution hypothesis information using the results of such processing.

The detecting unit 12 detects differences between first solution hypothesis information, which was generated by the integrating unit 11 integrating one or more first solution hypothesis information (that is, information representing the solution hypotheses before changing the conditions) that was generated using the observed event information and the rule information, and second integrated solution hypothesis information, which was generated by the integrating unit 11 integrating one or more second solution hypothesis information (that is, information representing the solution hypotheses after the conditions have been changed) that was generated after one or both of the observed event information and the rule information has been changed.

Note that when there is one first solution hypothesis and one second solution hypothesis, the detection unit 12 detects the differences between the first solution hypothesis and the second solution hypothesis.

When there is one first solution hypothesis and a plurality of second solution hypotheses, the detection unit 12 sets the first solution hypothesis as the first integrated solution hypothesis information and detects differences with the second integrated solution hypothesis information.

When there are a plurality of first solution hypotheses and one second solution hypothesis, the detection unit 12 sets the second solution hypothesis as the second integrated solution hypothesis information and detects differences with the first integrated solution hypothesis information.

In more detail, the detection unit 12 sets observed literal information representing observed literals, hypothetical literal information representing hypothetical literals, backward inference operation information representing backward inference operations, and unification operation information representing unification operations, all of which are included in the first integrated solution hypothesis information and the second integrated solution hypothesis information, as elements and derives a difference set and an intersection set of the first integrated solution hypothesis information and the second integrated solution hypothesis information.

Based on these derived results, the detecting unit 12 detects the differences between the first integrated solution hypothesis information and the second integrated solution hypothesis information.

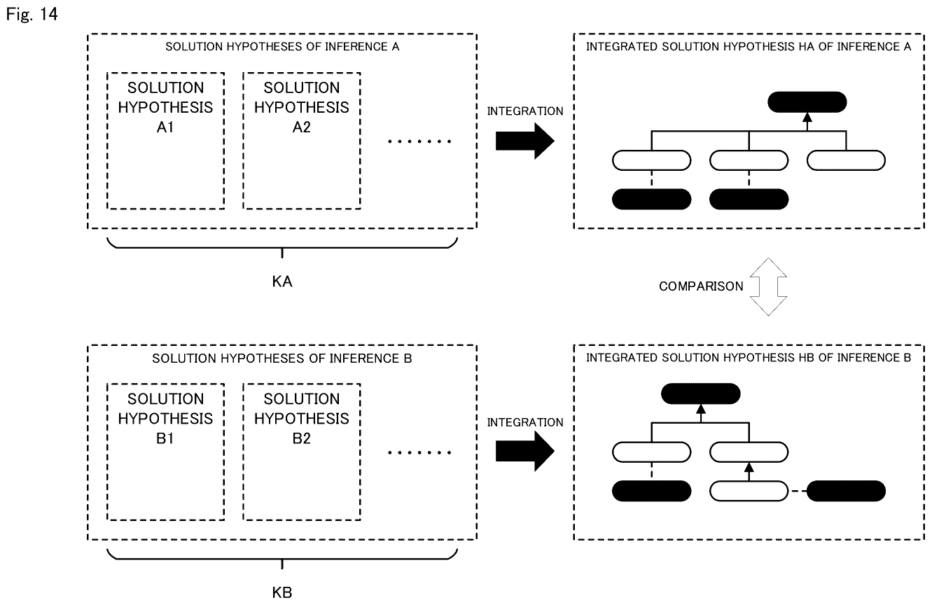

The detection of differences between integrated solution hypothesis information will now be described. FIG. 14 is a diagram illustrating a comparison of integrated solution hypotheses.

The example in FIG. 14 depicts a comparison between an integrated solution hypothesis HA in which KA solution hypotheses of Inference A has been integrated and an integrated solution hypothesis HB in which KB solution hypotheses of Inference B have been integrated.

The detection unit 12 uses the integrated solution hypothesis HA and the integrated solution hypothesis HB to derive an intersection set (that is, HA∩HB: a common part that remains unchanged even when the conditions change).

In addition, the detecting unit 12 uses the integrated solution hypothesis HA and the integrated solution hypothesis HB to derive a difference set (HA−HB: a part that disappears due to the change in conditions) and a difference set (HB−HA: a part that appears due to the change in conditions.

That is, the detection unit 12 derives the elements that disappear based on a difference set obtained by subtracting elements of the second integrated solution hypothesis information from the elements of the first integrated solution hypothesis information. The detection unit 12 also derives elements that appear based on the difference set obtained by subtracting the elements of the first integrated solution hypothesis information from the elements of the second integrated solution hypothesis information.

Note that an intersection set is a set of elements that are regarded as the same. A difference set, as opposed to an intersection set, is a set of elements that are not the same. The determination of whether elements are the same or not is the same as during the integration of solution hypotheses described earlier.

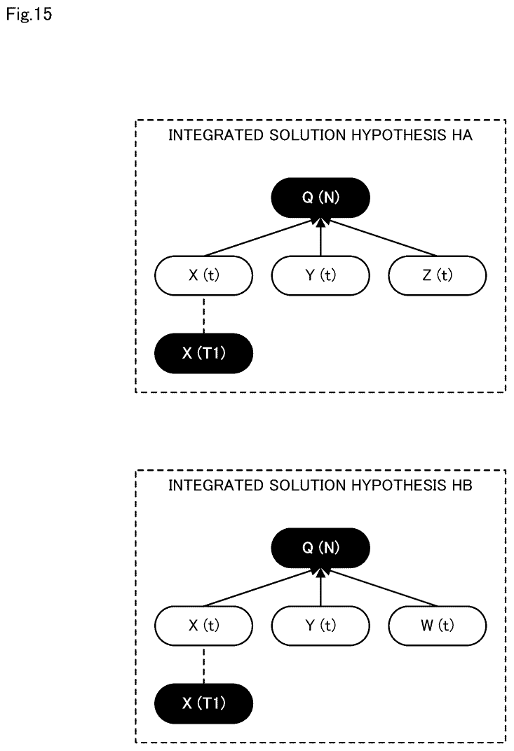

FIG. 15 is a diagram illustrating the disappearance and appearance of hypothetical literals.

In the example in FIG. 15, the common parts of the integrated solution hypothesis HA and the integrated solution hypothesis HB are the observed literals “Q(N)” and “X(T1)”, the hypothetical literals “X(t)” and “Y(t)”, the backward inference operations “X(t)→Q(N)” and “Y(t)→Q(N)”, and the unification operation “X(t)˜X(T1)”.

In the example of FIG. 15, the difference (HA−HB) between the integrated solution hypothesis HA and the integrated solution hypothesis HB is the hypothetical literal “Z(t)” and the backward inference operation “Z(t)→Q(N)”. The difference (HB−HA) between the integrated solution hypothesis HB and the integrated solution hypothesis HA is the hypothetical literal “W(t)” and the unification operation “W(t)→Q(N)”.

As mentioned above, in the example embodiments, first, integrated solution hypothesis information, which has been generated by integrating a plurality of solution hypotheses generated using the same weighted abduction process, gathers together parts that are duplicated in a plurality of solution hypotheses into one by deriving a union of each type of element (literals, backward inference operations, or unification operations) that compose each solution hypothesis information.

After this, in the example embodiments, a comparison between the integrated solution hypothesis HA, in which a plurality of solution hypotheses before the conditions change have been integrated, and the integrated solution hypothesis HB, in which a plurality of solution hypotheses after the condition change have been integrated, is performed by comparing a set composed of elements (literals, backward inference operations, and unification operations) that compose each solution hypothesis out of all solution hypotheses obtained by inference A (that is, a set in which duplicates have been removed) and a set composed of elements (literals, backward inference operations, and unification operations) that compose each solution hypothesis out of all solution hypotheses obtained by Inference B (that is, a set in which duplicates have been removed).

In addition, deriving the common part or differences between the integrated solution hypothesis HA and the integrated solution hypothesis HB is equivalent to deriving the common part or differences between all solution hypotheses of Inference A and all solution hypotheses of Inference B. That is, the common part is a hypothetical part that will be obtained regardless of whether the conditions change, and the differences are the overall differences between the solution hypotheses due to the conditions changing.

This means that according to the example embodiments, by comparing sets from which duplicates have been eliminated in advance, that is, comparing integrated solution hypothesis information in which a plurality of solution hypotheses from before a change in the conditions have been integrated and the integrated solution hypothesis information in which a plurality of solution hypotheses from after a change in the conditions have been integrated, it is possible to eliminate the cancelling out of hypothetical literals that disappear and appear between individual comparison results as described earlier, which makes it easy to detect differences in the inference results before and after a change in the conditions. As a result, differences in the inference results before and after a change in the conditions can be presented to the user in an easy-to-understand manner.

### System Configuration

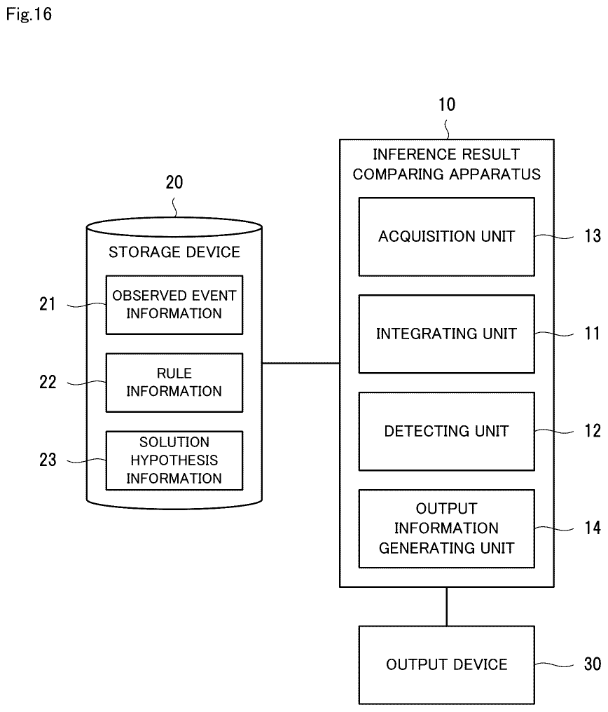

Next, the configuration of the information processing apparatus 10 according to the example embodiments will be described in more detail with reference to FIG. 16. FIG. 16 is a diagram illustrating one example of a system including an information processing apparatus.

As depicted in FIG. 16, the system 100 includes an information processing apparatus 10, a storage device 20, and an output device 30. The information processing apparatus 10 includes an acquisition unit 13, the integrating unit 11, the detecting unit 12, and an output information generating unit 14.

As examples, the information processing apparatus 10 is a processor such as a CPU (Central Processing Unit), a programmable device such as an FPGA (Field-Programmable Gate Array), or a GPU (Graphics Processing Unit), or an apparatus, such as a circuit, a server computer, a personal computer, or a mobile terminal which is equipped with at least one of such processors, and is an apparatus (or “inference result comparing apparatus”) used to compare inference results.

The storage device 20 may be a database, a server computer, a circuit including a memory, or the like. The storage device 20 stores at least observed event information 21, rule information 22, and solution hypothesis information 23. Although the storage device 20 is provided outside the information processing apparatus 10 in the example in FIG. 16, it is also possible to provide the storage device 20 inside the information processing apparatus 10.

The solution hypothesis information 23 includes one or more solution hypothesis information corresponding to before a change to the conditions and one or more solution hypothesis information corresponding to after a change to the conditions. Each of the solution hypothesis information includes literal information (observed literal information and hypothetical literal information), backward inference operation information, and unification operation information.

The output device 30 obtains output information, described later, that has been converted into an outputtable format by the output information generating unit 14, and outputs generated images, audio, and the like based on this output information. As one example, the output device 30 is an image display device that uses a liquid crystal display, an organic EL (Electro Luminescence) display, or a CRT (Cathode Ray Tube). This image display device may also include an audio output device, such as a speaker. Note that the output device 30 may be a printing device, such as a printer.

The information processing apparatus will now be described.

The acquisition unit 13 acquires, based on conditions specified by the user using an input device (not illustrated), solution hypothesis information corresponding to the specified conditions from solution hypothesis information stored in the storage device 20. As one example, the acquisition unit 13 acquires one or more first solution hypothesis information for before a change to the conditions and one or more second solution hypothesis information for after a change to the conditions.

The integrating unit 11 integrates one or more of the first solution hypothesis information from before the change to the conditions and one or more second solution hypothesis information from after the change to the conditions.

In more detail, the integrating unit 11 acquires the first solution hypothesis information from before the change to the conditions and the corresponding second solution hypothesis information from after the change to the conditions from the acquisition unit 13. Next, the integrating unit 11 integrates one or more first solution hypothesis information to generate the first integrated solution hypothesis information. The integrating unit 11 also integrates one or more second solution hypothesis information to obtain the second integrated solution hypothesis information.

Note that when a change to the condition information stored in the storage device 20 has been detected, a weighted abduction process may be executed based on the changed condition information to generate solution hypothesis information, and the generated solution hypothesis information and the changed condition information may be stored in association with each other.

The detection unit 12 compares first integrated solution hypothesis information, which has been generated by integrating one or more solution hypothesis information from before a change to the conditions and second integrated solution hypothesis information, which has been generated by integrating one or more solution hypothesis information from after the change to the conditions and detects a comparison result (differences).

To present the comparison result (differences) between the first integrated solution hypothesis information and the second integrated solution hypothesis information to the user, the output information generating unit 14 uses the elements of an intersection set (that is, the common part) and the elements of a differences set (that is, elements that disappear and elements that appear) to generate output information to be outputted to the output device 30.

The output information generating unit 14 generates output information that distinguishes between and outputs elements of the intersection set (that is, a common part) and elements of the differences set (that is, elements that disappear and elements that appear).

The presentation of the comparison results (differences) between the first integrated solution hypothesis information and the second integrated solution hypothesis information will now be described.

As examples presentations of comparison results,
(i) Presentation of disappearances and appearances of hypothetical literals
(ii) Presentation of changes in appearance locations of hypothetical literals,
(iii) Presentation of first structural changes to backward inference operations,
(iv) Presentation of second structural changes to backward inference operations, and
(v) Presentation of the presence or absence of unification operations
   will be described.

Note that (i) to (v) are examples of comparison results that can be presented, and the comparison results that are actually presented may be a combination of the above but are also not limited to the above. The comparison results referred to here are presented to the user.

As one example, a graph is presented in which literals are represented using nodes (rectangles with rounded corners), backward inference operations (directed links (arrows)), and unification operations (undirected links (dashed lines)). When doing so, respective elements belonging to the intersection set and the differences set can be distinguished.

### (i) Presentation of Disappearances and Appearances of Hypothetical Literals

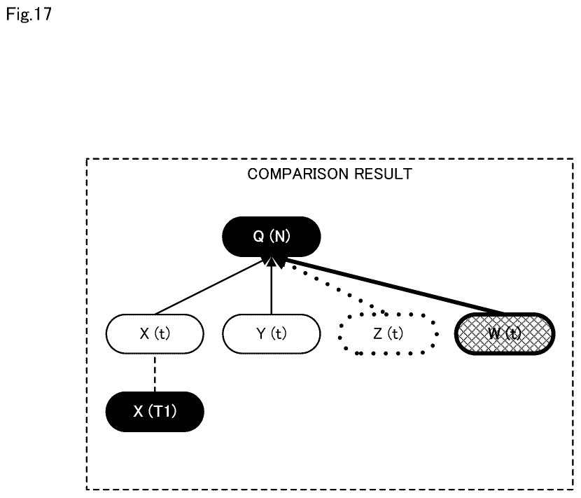

FIG. 17 is a diagram illustrating the presentation of disappearances and appearances of hypothetical literals. In the example in FIG. 17, disappearances and appearances of hypothetical literals are presented as a comparison result between the integrated solution hypothesis HA and the integrated solution hypothesis HB in FIG. 15 described above.

In the example in FIG. 17, the common parts of the integrated solution hypothesis HA and the integrated solution hypothesis HB are the observed literals “Q(N)” and “X(T1)”, the hypothetical literals “X(t)” and “Y(t)”, the backward inference operations “X(t)→Q(N)”, “Y(t)→Q(N)”, and the unification operation “X(t)˜X(T1)”.

In addition, in the example in FIG. 17, the difference (HA−HB) between the integrated solution hypothesis HA and the integrated solution hypothesis HB is the hypothetical literal “Z(t)” and the backward inference operation “Z(t)→Q(N)”, which correspond to elements that disappear due to a change to the conditions. The differences (HB−HA) between the integrated solution hypothesis HB and the integrated solution hypothesis HA are the hypothetical literal “W(t)” and the unification operation “W(t)→Q(N)”, which correspond to elements that appear due to the change to the conditions.

In the example in FIG. 17, the frame line of the node representing the hypothetical literal “Z(t)” that disappears is drawn using a dotted line, and the directed link (arrow) of the backward inference operation “Z(t)→Q(N)” that disappears is drawn using a dotted line.

In addition, the frame of the node representing the hypothetical literal “W(t)” that appears is internally shaded, and the directed link (arrow) of the unification operation “W(t)→Q(N)” is drawn using a thick line.

However, the manner in which disappearance and appearance are represented is not limited to the representation described above, and as one example may be a change in the color scheme.

By presenting information to the user as depicted in FIG. 17, it is easy for the user to understand that a hypothetical literal has disappeared or appeared due to the change to the conditions.

As a detailed example, in the field of cybersecurity, assume that Q is a predicate indicating a query for performing abduction (that is, a query as to whether there has been a cyberattack), that Z is a predicate indicating a trace of “file compression”, and that W is a predicate indicating a trace of “file encryption”. From FIG. 17, it can be understood that for the hypothetical literal generated from the observed literal Q(N), “Z(t)” disappears and “W(t)” appears due to the change to the conditions. In other words, it is easy to understand that the trace hypothesis generated from Q=“query as to whether there has been a cyberattack” has changed from Z=“file compression” to W=“file encryption”.

### (ii) Presentation of Changes in Appearance Location of Hypothetical Literals

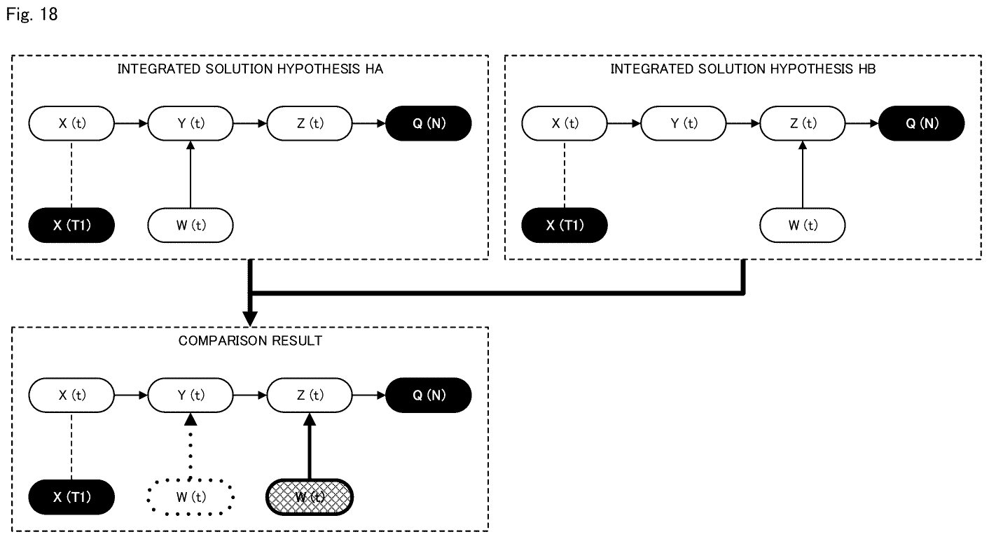

FIG. 18 is a diagram illustrating the presentation of changes in the appearance locations of hypothetical literals. In the example in FIG. 18, the common parts of the integrated solution hypothesis HA and the integrated solution hypothesis HB are the observed literals “Q(N)” and “X(T1)”, the hypothetical literals “X(t)”, “Y(t)”, and “Z(t)”, the backward inference operations “X(t)→Y(t)”, “Y(t)→Z(t)”, and “Z(t)→Q(N)”, and the unification operation “X(t)˜X(T1)”.

In addition, in the example of FIG. 18, the difference (HA−HB) between the integrated solution hypothesis HA and the integrated solution hypothesis HB is the hypothetical literal “W(t)” and the backward inference operation “W(t)→Y(t)”, which correspond to elements that disappear due to a change to the conditions. In addition, the difference (HB−HA) between the integrated solution hypothesis HB and the integrated solution hypothesis HA is the hypothetical literal “W(t)” and the backward inference operation “W(t)→Z(t)”, which correspond to elements that appear due to a change to the conditions. That is, the appearance position of the hypothetical literal “W(t)” changes.

In the example in FIG. 18, the frame line of the node representing the hypothetical literal “W(t)” that disappears is drawn as a dotted line and the directed link (arrow) of the backward inference operation “W(t)→Y(t)” is also drawn as a dotted line.

The frame of the hypothetical literal “W(t)” that appears is internally crosshatched, and the directed link (arrow) of the backward inference operation “W(t)→Z(t)” is drawn as a thick line.

However, the manner in which disappearance and appearance are represented is not limited to the representation described above, and as one example may be a change in the color scheme.

By presenting information to the user as depicted in FIG. 18, the user can easily understand the change in the positional relationship of the hypothetical literal in the solution hypotheses. That is, the user can easily understand which literals have been generated by backward inference operations starting from which literals.

As a specific example in the field of cybersecurity, assume that Y is a predicate indicating a trace of “communication with a suspicious server”, Z is a predicate indicating a trace of “downloading of a suspicious file,” and W is a predicate indicating a trace of “registration of a periodically executed task”. It can be understood from FIG. 18 that the hypothetical literal that generates “W(t)” has changed from “Y(t)” to “Z(t)” due to the change to the conditions. In other words, it can be easily understood that the hypothesis of the trace that W=“registration of a periodically executed task” has changed and is premised on a hypothesis of a trace of Z=“download of a suspicious file” and not a hypothesis of a trace of Y=“communication with a suspicious server”.

(iii) Presentation of First Structural Changes to Backward Inference Operations

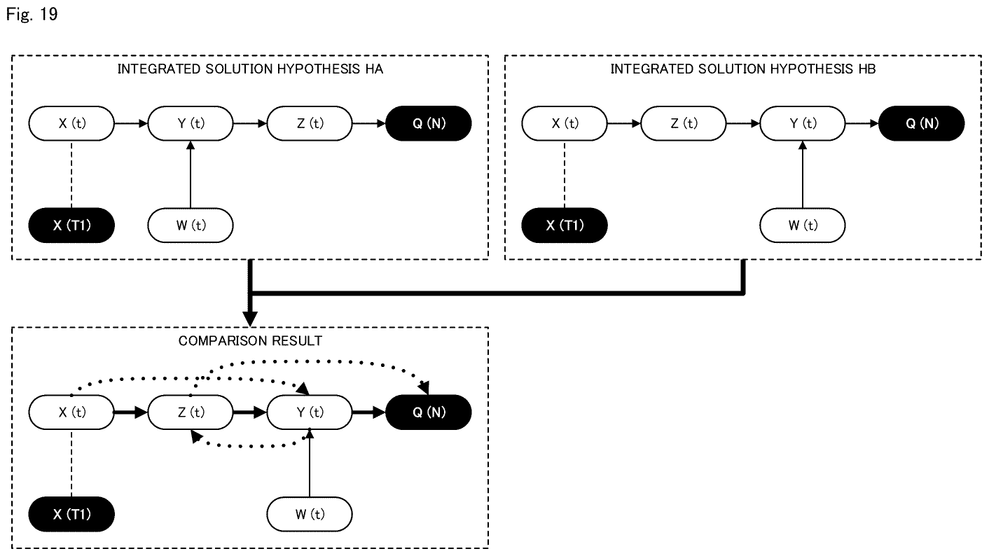

FIG. 19 is a diagram illustrating the presentation of first structural changes to a backward inference operation. In the example in FIG. 19, the common parts of the integrated solution hypothesis HA and the integrated solution hypothesis HB are the observed literals “Q(N)” and “X(T1)”, the hypothetical literals “X(t)”, “Y(t)”, “Z(t)”, and “W(t)”, the backward inference operation “W(t)→Y(t),” and the unification operation “X(t)˜X(T1).”

In addition, in the example in FIG. 19, the differences (HA−HB) between the integrated solution hypothesis HA and the integrated solution hypothesis HB are the backward inference operations “X(t)→Y(t)”, “Z(t)→Q(N)”, and “Y(t)→Z(t)”, and correspond to elements that disappear due to a change to the conditions. In addition, the differences (HB−HA) between the integrated solution hypothesis HB and the integrated solution hypothesis HA are the backward inference operations “X(t)→Z(t)”, “Z(t)→Y(t)”, and “Y(t)”→Q(N)”, and correspond to elements that appear due to a change to the conditions. That is, the order in which the hypothetical literals “X(t)”, “Y(t)”, and “Z(t)” are generated by the backward inference operations changes. Note that there is no increase or decrease in hypothetical literals.

In the example in FIG. 19, the directed links (arrows) of the backward inference operations “X(t)→Y(t)”, “Z(t)→Q(N)”, and “Y(t)→Z(t)” that disappear are drawn with dotted lines.

Also, the directed links (arrows) of the backward inference operations “X(t)→Z(t)”, “Z(t)→Y(t)”, and “Y(t)→Q(N)” that appear are drawn with thick lines.

However, the manner in which disappearance and appearance are represented is not limited to the representation described above, and as one example may be a change in the color scheme.

By providing the user with a presentation like that depicted in FIG. 19, even when hypothetical literals are the same, the user can easily understand the direction of the backward inference operations that link such literals. That is, the user can understand the difference in the order in which hypothetical literals are generated.

As a specific example, in the field of cybersecurity, assume that X is a predicate that indicates a trace of “execution of a suspicious program,” Y is a predicate that indicates a trace of “regular communication with a suspicious server,” and Z is a predicate that indicates a trace of “file encryption”. From FIG. 19, the order along the links of the hypothetical literals changes from “X(t)”→“Y(t)”→“Z(t)” to “X(t)”→“Z(t)”→“Y(t)” due to the change to the conditions. In other words, it is easy to understand that the order of operations to be performed has changed due to an attack.

### (iv) Presentation of Second Structural Changes to Backward Inference Operations

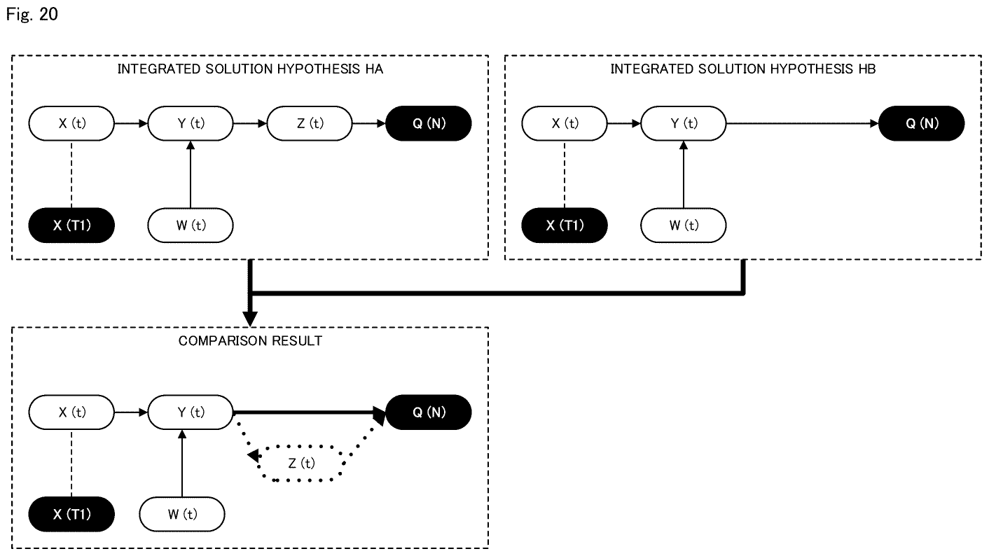

FIG. 20 is a diagram illustrating the presentation of second structural changes to backward inference operations. In the example in FIG. 20, the common parts of the integrated solution hypothesis HA and the integrated solution hypothesis HB are the observed literals “Q(N)” and “X(T1)”, the hypothetical literals “X(t)”, “Y(t)”, and “W(t)”, the backward inference operations “X(t)→Y(t)” and “W(t)→Y(t)”, and the unification operation “X(t)˜X(T1)”.

In the example of FIG. 20, the differences (HA−HB) between the integrated solution hypothesis HA and the integrated solution hypothesis HB are the hypothetical literal “Z(t)” and the backward inference operations “Y(t)→Z(t)” and “Z(t)→Q(N)”, and correspond to elements that disappear due to a change to the conditions. The difference (HB−HA) between the integrated solution hypothesis HB and the integrated solution hypothesis HA is a backward inference operation “Y(t)→Q(N)” and corresponds to an element that appears due to a change to the conditions. That is, the generation of a hypothetical literal by the backward inference operation changes from “Y(t)→Z(t)→Q(N)” to “Y(t)→Q(N).”

In the example in FIG. 20, the frame line of the node representing the disappearing hypothetical literal “Z(t)” is drawn as a dotted line, and the directed links (arrows) of the backward inference operations “Y(t)→Z(t)” and “Z(t)→Q(N)” are drawn as dotted lines. Also, the directed link (arrow) of the backward inference operation “Y(t)→Q(N)” that appears is drawn as a thick line.

However, the manner in which disappearance and appearance are represented is not limited to the representation described above, and as one example may be a change in the color scheme.

By presenting the user with information as depicted in FIG. 20, it becomes possible for the user to understand the difference in the number of backward inference operations and the accompanying difference in structure, that is, that a short cut of one backward inference operation has been made. When another example where the integrated solution hypothesis HB in this example corresponds to before a change to the conditions and the integrated solution hypothesis HA corresponds to after the change to the conditions, the elements that disappear and the elements that appear will be the opposite of those in the example in FIG. 20. This means that the number of backward inference operations increases by one. In this case also, it is possible to understand the difference in the number of backward inference operations and the resulting difference in structure, in the same way as the example in FIG. 20.

As a specific example, in the field of cybersecurity, assume that X is a predicate that indicates a trace of “execution of a suspicious program”, Y is a predicate that indicates a trace of “regular communication with a suspicious server”, and Z is a predicate that indicates a trace of “downloading a suspicious file”. As depicted in FIG. 20, the order of the links of the hypothetical literals has changed due to the change to the conditions from “X(t)”→“Y(t)”→“Z(t)” to “X(t)”→“Y(t)”, which is to say, “Z(t)” has disappeared. In other words, it is easy to understand that the operations performed have changed due to an attack so that Z=“downloading a suspicious file” is no longer performed.

### (v) Presentation of the Presence or Absence of Unification Operations

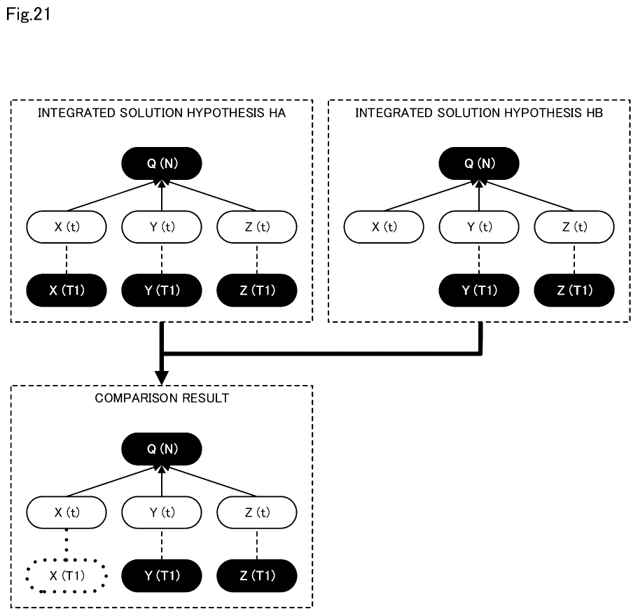

FIG. 21 is a diagram illustrating the presentation of the presence or absence of unification operations. In the example in FIG. 21, the common parts of the integrated solution hypothesis HA and the integrated solution hypothesis HB are the observed literals “Q(N)”, “Y(T)”, and “Z(T)”, the hypothetical literals “X(t)”, “Y(t)”, and “Z(t)”, the backward inference operations “X(t)→Q(N)”, “Y(t)→Q(N)”, and “Z(t)→Q(N)”, and the unification operations “Y(t)˜Y(T1)” and “Z(t)˜Z(T1)”.

In addition, in the example in FIG. 21, the differences (HA−HB) between the integrated solution hypothesis HA and the integrated solution hypothesis HB are the observed literal “X(T1)” and the unification operation “X(t)˜X(T1)”. These correspond to elements that disappear due to a change to the conditions.

In the example in FIG. 21, the observed literal “X(T1)” and the undirected link (broken line) of the unification operation “X(t)˜X(T1)” that disappear are drawn using dotted lines.

However, the manner in which disappearance is represented is not limited to the representation described above, and as one example may be a change in the color scheme.

By presenting information like that depicted in FIG. 21 to the user, it becomes possible for the user to understand that although a hypothetical literal was unified with an observed literal before the change, unification is no longer possible after the change because a change has occurred whereby the hypothetical literal remains a hypothesis (that is, the hypothetical literal is not linked to an observed fact).

As a specific example, in the field of cybersecurity, assume that X is a predicate that indicates a trace of “execution of a suspicious program”, Y is a predicate that indicates a trace of “regular communication with a suspicious server”, and Z is a predicate that indicates a trace of “downloading a suspicious file”. It can be understood from FIG. 21 that due to the change to the conditions, the observed literal that is unified with the hypothetical literal “X(t)” has disappeared.

In other words, it is easy to understand that there is no observation that corresponds to the hypothesis that trace X=“execution of a suspicious program” (so that it may be necessary to perform a more detailed search of corresponding observations from logs and the like).

### [Apparatus Operation]

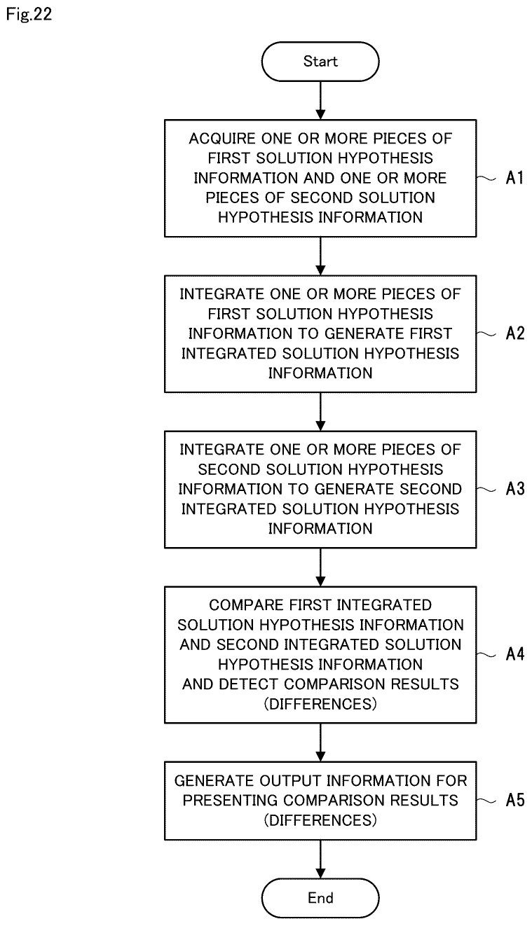

Next, the operation of the information processing apparatus according to the example embodiment will be described using FIG. 22. FIG. 22 is a diagram illustrating the operation of an information processing apparatus. The following description will refer to the drawings as appropriate. In the example embodiment, an information processing method is implemented by operating the information processing apparatus. Accordingly, a description of the operation of the information processing apparatus is given below in place of describing an information processing method according to the example embodiment.

As depicted in FIG. 22, the acquisition unit 13 acquires, based on conditions specified by the user using an input device (not shown), solution hypothesis information corresponding to the specified conditions from the solution hypothesis information stored in the storage device 20 (step A1).

In step A1, the acquisition unit 13 acquires one or more first solution hypothesis information for before a change to the conditions and one or more second solution hypothesis information for after a change to the conditions.

The integrating unit 11 integrates the one or more first solution hypothesis information from before the change to the conditions (step A2) and integrates the one or more second solution hypothesis information from after the change to the conditions (step A3). Note that the processing order of step A2 and step A3 may be reversed.

In more detail, in step A2, the integrating unit 11 first acquires the first solution hypothesis information from before the change to the conditions from the acquiring unit 13. Next, in step A2, the integrating unit 11 integrates the one or more first solution hypothesis information to generate the first integrated solution hypothesis information.

In step A3, first, the integrating unit 11 acquires second solution hypothesis information from after the change to the conditions from the acquiring unit 13. Next, in step A3, the integrating unit 11 integrates one or more second solution hypothesis information to obtain the second integrated solution hypothesis information.

The detecting unit 12 compares the first integrated solution hypothesis information generated by integrating the one or more solution hypothesis information from before the change to the conditions and the second integrated solution hypothesis information generated by integrating the one or more solution hypothesis information from after the change to the conditions and detects a comparison result (differences) (step A4).

The output information generating unit 14 generates output information to be outputted to the output device 30 in order to present the comparison result (differences) between the first integrated solution hypothesis information and the second integrated solution hypothesis information to the user (Step A5).

In step A5, the user is presented with information such as (i) disappearances and appearances of hypothetical literals, (ii) changes in the appearance locations of hypothetical literals, (iii) first structural changes to backward inference operations, (iv) second structural changes to backward inference operations, and (v) presence or absence of unification operations described above.

### Effects of Example Embodiment

As described above, according to the example embodiments, the integrated solution hypothesis information generated by integrating a plurality of solution hypotheses generated using a weighted abduction process derives unions of elements (literals, backward inference operations, and unification operations) that compose the respective solution hypothesis information, and by doing so can gather together parts that are duplicated in a plurality of solution hypotheses.

Also with the example embodiments, by comparing an integrated solution hypothesis HA that in which a plurality of pieces of solution hypothesis information before a change to the conditions are integrated and an integrated solution hypothesis HB in which a plurality of pieces of solution hypothesis information after the change to the conditions are integrated, a set composed of elements (literals, background inference operations, and unification operations) that compose all of the respective solution hypothesis information obtained by Inference A (a set from which duplication has been eliminated) and a set composed of elements (literals, background inference operations, and unification operations) that compose all of the respective solution hypothesis information obtained by Inference B (a set from which duplication has been eliminated) are compared.

In addition, deriving the common part or differences between the integrated solution hypothesis HA and the integrated solution hypothesis HB is equivalent to deriving the common part or differences between all solution hypothesis information of Inference A and all solution hypothesis information of Inference B. That is, the common part is a hypothetical part obtained regardless of whether the conditions change, and the differences are the overall differences in the solution hypothesis information caused by the change to the conditions.

This means that according to the example embodiment, by comparing sets from which duplicates have been eliminated in advance, that is, comparing integrated solution hypothesis information that integrates a plurality of pieces of solution hypothesis information from before a change to the conditions and integrated solution hypothesis information that integrates a plurality of pieces of solution hypothesis information from after the change to the conditions, it is possible to eliminate the cancelling out of disappearances and appearances of hypothetical literals between the individual comparison results as described earlier, which makes it easy to detect the differences between the inference results before and after the change to the conditions. As a result, the difference between the inference results before and after a change to the conditions can be presented to the user in an easy-to-understand manner.

When the conditions have changed, the user can easily understand changes like those described below. That is, the user can easily understand the disappearance and appearance of hypothetical literals, including their positional relationships in the solution hypotheses (that is, which literals have been generated by backward inference operations starting from which literals).

In addition, the user can understand differences in the way hypothetical literals are generated by backward inference operations, that is, differences in structure such as increases or decreases in the number of backward inference operations, in the directions of directed links, and the like (as one example, a case where hypothetical literals are the same but the backward inference operations that link such literals differ).

In addition, the user can understand the differences between whether a generated hypothetical literal is linked to an observed fact or whether the literal remains a hypothesis.

One example of a specific effect in the field of cybersecurity is described below.

If an important attack method, such as spreading through infection, has appeared in a hypothesis through changes over time in observations, it can be understood that countermeasures are necessary.

If traces of an attack remain as a hypothesis and have not been unified by deleting or modifying observations, it can be understood that it is necessary to search for corresponding traces.

If the order and/or structure of an attack method has changed by modifying rules, the flow of an attack can be interpreted more rationally.

### [Program]

The program according to the example embodiment may be a program that causes a computer to execute steps A1 to A5 shown in FIG. 22. By installing this program in a computer and executing the program, the information processing apparatus and the information processing method according to the example embodiment can be realized. In this case, the processor of the computer performs processing to function as the acquisition unit 13, the integrating unit 11, the detecting unit 12, and the output information generating unit 14.

Also, the program according to the embodiment may be executed by a computer system constructed by a plurality of computers. In this case, for example, each computer may function as any of the acquisition unit 13, the integrating unit 11, the detecting unit 12, and the output information generating unit 14.

### [Physical Configuration]

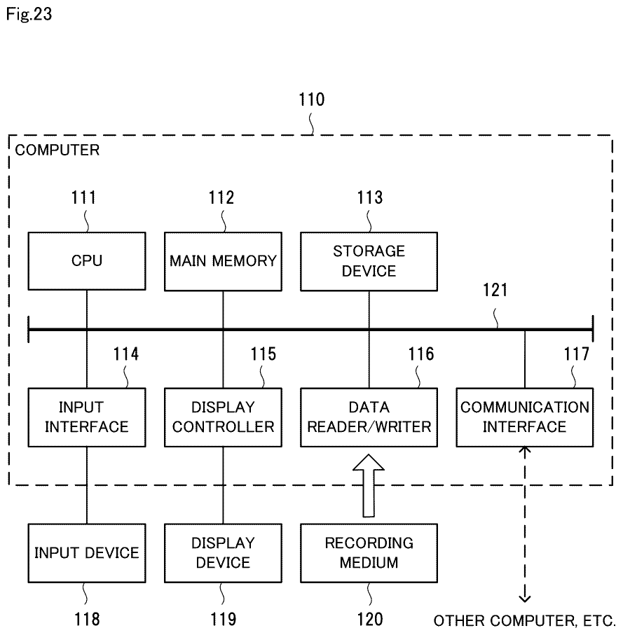

Here, a computer that realizes the information processing apparatus by executing the program according to an example embodiment will be described with reference to FIG. 23. FIG. 23 is a diagram illustrating an example of a computer that realizes the information processing apparatus in the example embodiment.

As shown in FIG. 23, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the information processing apparatus 10 according to this example embodiment can also be realized by using hardware corresponding to each unit. Furthermore, a portion of the information processing apparatus 10 may be realized by a program, and the remaining portion realized by hardware.

Although the example embodiment has been described with reference to exemplary embodiments, the example embodiments is not limited to the above example embodiments.

Within the scope of the example embodiment, various changes that can be understood by those skilled in the art can be made to the configuration and details of the example embodiment.

### INDUSTRIAL APPLICABILITY

As described above, it is possible to detect the difference between inference results from before a change to conditions and inference results from after the change to the conditions, even when there is a plurality of solution hypotheses before and after a change to the conditions. In addition, it is useful in a field where analysis of cyber-attack is needed.

### REFERENCE SIGNS LIST

10 Information processing apparatus
11 Integrating unit
12 Detecting unit
13 Acquisition unit
14 Output information generating unit
20 Storage device
21 Observed event information
22 Rule information
23 Solution hypothesis information
30 Output device
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. An information processing apparatus comprising:
at least one memory storing instructions; and
at least one processor configured to execute the instructions to:
integrate, using observed event information representing an observed event that has been observed and rule information representing inference knowledge, a plurality of pieces of solution hypothesis information generated by weighted abduction processing; and
detect differences between first integrated solution hypothesis information, which has been generated by the integrating means integrating one or more pieces of first solution hypothesis information generated using the observed event information and the rule information, and second integrated solution hypothesis information, which has been generated by the integrating means integrating one or more pieces of second solution hypothesis information generated when one or both of the observed event information and the rule information have changed.

2. The information processing apparatus according to claim 1,
wherein the one or more processors further:
sets observed literal information representing an observed literal, hypothetical literal information representing a hypothetical literal, backward inference operation information representing a backward inference operation, and unification operation information representing a unification operation, all of which are included in the first integrated solution hypothesis information and the second integrated solution hypothesis information, as elements to derive an intersection set and a difference set of the first integrated solution hypothesis information and the second integrated solution hypothesis information, and detects the differences between the first integrated solution hypothesis information and the second integrated solution hypothesis information based on results of the deriving.

3. The information processing apparatus according to claim 2,
wherein the one or more processors further:
derives elements that disappear based on a difference set obtained by subtracting elements of the second integrated solution hypothesis information from elements of the first integrated solution hypothesis information and derives elements that appear based on a difference set obtained by subtracting elements of the first integrated solution hypothesis information from elements of the second integrated solution hypothesis information.

4. The information processing apparatus according to claim 3,
wherein the one or more processors further:
generates, using the elements of the intersection set, the elements that disappear, and the elements that appear, output information representing the differences between the first integrated solution hypothesis information and the second integrated solution hypothesis information for outputting to an output device.

5. The information processing apparatus according to claim 4,
wherein the one or more processors further:
generates the output information to be outputted by distinguishing between the elements of the intersection set, the elements that disappear, and the elements that appear.

6. An information processing method in which an information processing apparatus executes processing comprising:
generating first integrated solution hypothesis information by integrating one or more pieces of first solution hypothesis information which have been generated weighted abduction processing using condition information including observed event information representing an observed event that has been observed and rule information representing inference knowledge;
generating second integrated solution hypothesis information by integrating one or more pieces of second solution hypothesis information, which have been generated using changed condition information in a case where one or both of the observed event information and the rule information in included in the condition information have changed; and
detecting differences between the first integrated solution hypothesis information and the second integrated solution hypothesis information.

7. Anon-transitory computer-readable recording medium that includes a program recorded thereon, the program including instructions that causes to carry out:
generating first integrated solution hypothesis information by integrating one or more pieces of first solution hypothesis information which have been generated weighted abduction processing using condition information including observed event information representing an observed event that has been observed and rule information representing inference knowledge;
generating second integrated solution hypothesis information by integrating one or more pieces of second solution hypothesis information, which have been generated using changed condition information in a case where one or both of the observed event information and the rule information in included in the condition information have changed; and
detecting differences between the first integrated solution hypothesis information and the second integrated solution hypothesis information.

8. The information processing apparatus according to claim 1,
wherein the information processing apparatus is used for cyber security.
